(19) United States
(12) Patent Application Publication
(10) Pub. No.: US 2012/0060090 A1
(43) Pub. Date: Mar. 8, 2012

(54) System for Automatic Mouse Control

(76) Inventor: George C. Ubersox, Shullsburg, WI (US)

(21) Appl. No.: 13/194,431

(22) Filed: Jul. 29, 2011

Related U.S. Application Data
(60) Provisional application No. 61/368,663, filed on Jul. 29, 2010.

(51) Int. Cl. G06F 3/00

(52) U.S. Cl. 715/704

(57) ABSTRACT

A system for automatic mouse operation where a mouse and an incorporated timer serve to facilitate communication between the mouse and an associated computer such that movements and actions typically designated to a mouse are conducted in an automated manner based on predetermined, user-defined timing and settings. In this manner, a user can program a mouse so that it operates on its own in terms of movement, timing and clicks. As a result, the typical functions of a mouse are automated. This automation also subscribes to pre-determined settings as prescribed by a user.

### CONTINUITY DATA

This is a non-provisional application of provisional patent application No. 61/368,663 filed on Jul. 29, 2010, and priority is claimed thereto.

### FIELD OF THE PRESENT INVENTION

The present invention relates to a mouse and an incorporated timer that serves to facilitate communication between the mouse and an associated computer such that movements and actions typically designated to a mouse are conducted in an automated manner based on predetermined timing and settings.

### BACKGROUND OF THE PRESENT INVENTION

It is no secret that computers have become a focal point of both the home and office, as well as virtually everywhere in-between due to laptop technology and wireless connectivity. Computer users typically focus on items such as reading documents and playing complex and detailed games. But they also conduct research and engage in business as well. All of this attention often causes users to lose track of time. In addition, users become so engrossed to their computer work that they cannot get away to do other things.

For example, countless users consider themselves “gamers.” This means that they spend an exorbitant amount of time on the computer playing games. In order to earn free online gaming time, users often use their computers to go online in order to earn what is commonly referred to as “badges.” These “badges” are essentially points toward free gaming coverage. However, in order to make the “badges” worthwhile, the user will have to spend hours on the computer clicking on various links and conducting online tasks in order to earn these “badges.” Naturally, time spent on the computer is time away from work, chores, family and other recreation. Users also spend that much more time staring at the computer screen to the detriment of their eyesight. Moreover, carpal tunnel syndrome can develop due to the constant movement and clicking of the mouse. As such, there is a need for a system that automatically performs various tasks in relation to the movement, scrolling and clicking of the mouse. The present invention solves this need by offering a system that allows the user to engage predetermined functions such that these predetermined mouse functions operate automatically and without the physical presence and reliance of the user.

A related problem revolves around time. Sometimes users become so engrossed in their computer work that they lose track of time. This again causes users to neglect work, school, chores, family and other items. Users have even been known to miss meals because they have been so engaged in a computer game or work. The present invention solves this problem by incorporating a position switch onto the mouse. The position switch serves as a virtual timer that facilitates communication between the mouse and the computer. In this manner, after a set amount of time as determined by the position switch, the mouse will automatically conduct a predetermined function. This could mean moving and clicking on a pause button or even a clock icon on the computer taskbar. In relation to someone conducting time management while scrolling through a lengthy document, the present invention can be timed to scroll down after a set period of time. The results are enhanced time management through the automatic functions of the present invention.

U.S. patent application 2004/0148392 filed by Cotte on Jul. 29, 2004 is a website having an event identification element. Cotte employs a website and processing capability to configure an event identification element that provides private communications between a user and an end user. Unlike the present invention, Cotte requires online processing elements and does not place the automated functions with the mouse. The same differences relate to other items such as U.S. patent application 2006/0182141 filed by Duggirala on Aug. 17, 2006. Duggirala is an apparatus and method for automatic adjustment of connection keep-halves. However, unlike the present invention, Duggirala is based on the processing aspect and not within the mouse.

U.S. patent application 2007/0169170 filed by Shiran on Jul. 19, 2007 is a method relating to session management by analysis of requests and responses. Shiran requires session management modules and a gateway to analyze patterns of use. This is in contrast to the present invention that does not analyze patterns of use but rather allows the user to set the mouse in terms of timing and function for automatic implementation.

U.S. patent application 2007/0120823 filed by Otsuka on May 31, 2007 is an automatic click input system. Otsuka serves to monitor a cursor and when the cursor is stopped for a predetermined period of time without activity, a click function automatically occurs. Unlike the present invention, Otsuka relates to a sensing mechanism to detect inactivity of the mouse prior to issuing a click. In contrast, the present invention allows the user to predetermine the time and then automatically perform mouse functions. In addition, the present invention is not limited to sensing inactivity, but instead allows the user to be proactive and determine the functions and movements while correlating predetermined timing for such automatic iterations. The same rationale set the present invention apart from items such as U.S. Pat. No. 6,137,479 issued to Olsen et al on Oct. 24, 2000. Olsen is a programmable computer pointing device that relies on extensive processing mechanisms to perform timekeeping functions. But again, the present invention contrasts with Olsen because it allows the user to be proactive and determine the functions and movements while correlating predetermined timing for such automatic iterations.

There is nothing currently available that seamlessly solves the need for an automated mouse function in terms of time-management and user functionality. The present invention solves this need by incorporating the functional ability on the mouse rather than extensively within the computer hardware and software. As such, the present invention provides a novel system for automatic mouse operation.

### SUMMARY OF THE PRESENT INVENTION

The present invention is a system for automatically operating a mouse. In other words, the present invention functions to allow a user to program a mouse such that it may operate independently from a user's actions and clicks. In this manner, the present invention provides a means such that the typical functions of a mouse are automated. This automation also subscribes to pre-determined settings as prescribed by a user.

The present invention, in its preferred embodiment, incorporates conventional communication between the mouse and a computer. This allows for such items as arrows and cursors to move and click at virtually all points on the computer display. The present invention incorporates a timing element into the communication process between the mouse and at least one associated computer.

The preferred embodiment incorporates a position switch onto the mouse. The position switch serves to regulate the frequency or timing of the clicks of the mouse. For example, if the position switch is set for 10 minutes then the mouse will communicate with the associated computer to click on a certain point or otherwise initiate a traditional mouse function every 10 minutes. It is envisioned that any duration could be set for the position switch such that 5 seconds or 50 minutes could be selected, as the timing switch is conventionally known. The position switch in the preferred embodiment is placed on the mouse and permits a user one or more time settings. In this manner, the present invention can be set so that after a specific period of time, the mouse will engage in a function such as scrolling down or clicking at a certain point on the computer display.

The preferred embodiment of the present invention also includes a recording mechanism. The recording mechanism operates under conventional means as it communicates between the mouse and the at least one associated computer. The recording mechanism in the preferred embodiment is incorporated into the position switch of the mouse. When a user activates the recording mechanism, the mouse, via its communication with the computer and/or any relevant software or drivers, will remember the control functions that the user manually conducts. This has similar properties to creating a macro, although the present invention significantly differs because the entire mouse movement is recorded and played back at the appropriate time. In this way, the present invention can conceivably initiate and complete tasks such as loading up and operating computer games and programs.

Upon activation of the recording mechanism, the movement and all clicks of the mouse will be recorded into a conventional memory mechanism. The user will then place the position switch to a specific time setting. When the time setting is activated via the position switch, the recording mechanism will be activated as the functions of the mouse are recalled. Once the next time setting is activated, the next iteration of this movement will commence. It is envisioned in an additional embodiment that multiple recordings can be made via conventional means to correlate with different periods of time as prescribed from the position switch.

### BRIEF DESCRIPTION OF THE DRAWINGS

FIG. 1 is a top view of the preferred embodiment of the present invention.

FIG. 2 is a flow chart that details an embodiment of the function of the present invention.

### DETAILED DESCRIPTION OF THE PREFERRED EMBODIMENT

The present invention relates to a mouse (5) that is in communication via conventional means with at least one computer (50). The mouse (5) in the preferred embodiment is conventional in terms of its sensory motion elements. This includes such examples as a ball or laser motion detector. When a user moves the mouse (5), a corresponding cursor on the display screen (60) of the computer (50) moves along with it. When the user clicks on either the left-click button (10) or the right-click button (20), the cursor on the display screen (60) also carries out the function of the click.

It is envisioned that associated mouse drivers are incorporated into the software of the computer (50) such that the conventional interaction between the mouse (5) and the computer (50) can operate in synch and communication. The drivers can be placed onto the computer (50) via conventional means such as downloading, disc, thumb drive, or CD-ROM. The mouse (5) itself is physically in communication with the computer (50) either through a conventional USB or comparable connection (15). This connection (15) also can relate to a conventional wireless transmitter/receiver that operates in communication with a transmitter/receiver located on the computer (50). It also should be noted that an additional embodiment includes a unifying receiving module to help make the present invention compatible to the computer (50).

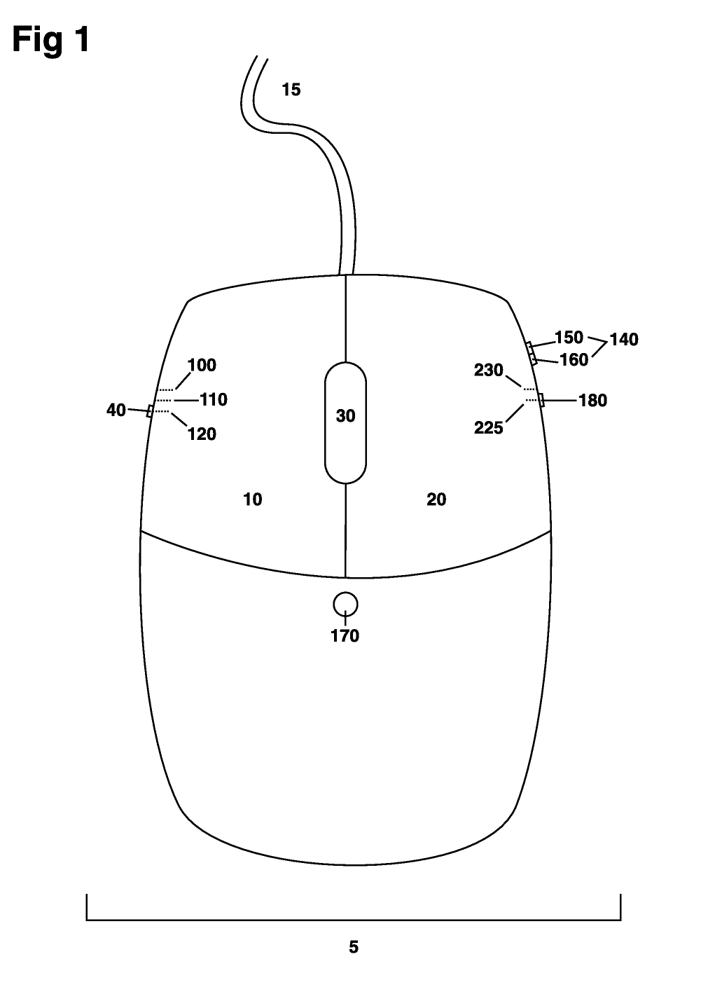

In FIG. 1, we see a view of the top view of an embodiment of the mouse (5) of the present invention. While the mouse (5) has the typical elements such as the left-click button (10), right-click button (20), and scroll wheel (30), the mouse (5) also includes a position switch (40). The position switch (40) provides timing settings that a user can use to regulate the automation of the present invention. In this manner, the position switch (40) will cause the mouse (5) to operate the cursor, scroll or click functions on the display screen (60) after a pre-determined amount of time.

In the embodiment of FIG. 1, we see that the position switch (40) has three positions, a top position (100), a middle position (110) and a bottom position (120), with each of the three positions set to represent a different amount of time. In the preferred embodiment of the present invention, the top position (100) is set for ten seconds, the middle position (110) is set for ten minutes, and the bottom position (120) is set for 30 minutes. A user can then move the position switch (40) to one of these desired timing positions. So if the user wants the cursor derived from the mouse (5) to click every 10 seconds, then the position switch (40) will be set in the top position (100). An example of such a use is when a user wants a web browser to continuously refresh a page as new data streams in or the user is waiting for a webpage to be updated. Instead of physically clicking the left-click button (10) of the mouse (5) over and over again, the user can merely set the position switch (40) to the top position (100) and the right-click button (20) function will automatically occur every ten seconds according to the predetermined setting of the position switch (40). Another example relates to when a user is analyzing a lengthy document on the computer display screen (60) and must conduct time management in order to complete the project. The user can set the position switch (40) to the middle position (110), which will cause the mouse (5) to automatically communicate to the computer (50) that the document should scroll down every ten minutes. This function serves as an alert in that the document will automatically scroll downward so that the user can move on with his or her analysis project. A final example relates to a situation where a user does not want a webpage or other computer program to time out after a specific period of time due to lack of activity. The user can set the position switch (40) to the bottom position (120), which is set for 30 minutes, and the mouse (5) can conventionally communicate with the computer (50) that a right-click function will occur over the location of the icon every 30 minutes. An additional embodiment of the present invention envisions a conventional mechanism to change the time settings for each of the positions of the position switch (40).

The mouse (5) in an additional embodiment also includes a recording mechanism (140). This additional embodiment is included in the depiction of the present invention as seen in FIG. 1. Like the timing element of the position switch (40), the recording mechanism (140) operates under conventional means as it communicates between the mouse (5) and the computer (50).

As seen in the embodiment portrayed in FIG. 1, the recording mechanism (140) includes a recording switch (150) and a stop recording switch (160). When a user activates the recording switch (150), the aforementioned communication between the mouse (5) and computer (50) is activated. Specifically, activation of the recording switch (150) will record all movements, scrolls and/or clicks derived from the mouse (5) and manifested onto the display screen (60). Once the user is ready for the recording to cease, the user will activate the stop recording switch (160). This will send a signal via conventional means to cease the recording of the mouse (5) movements and functions. In this embodiment, once a recording is activated and then stopped, the user can place the position switch (40) onto a desired setting. From there, once a predetermined amount of time has passed, the manifestation of the mouse (5) on the display screen (60) will activate and automatically perform the exact routine that was recorded.

Aforementioned elements of the present invention pertaining to the mouse (5) are envisioned to receive power and consequently operability from a direct connection to the computer (40). Of course, the embodiment relates to wired versions of the present invention. In wireless embodiments, a conventional battery is placed into a conventional battery compartment on preferably the bottom of the mouse (5), alongside a recessed on/off power switch (not shown in FIG. 1). An embodiment of the present invention as seen in FIG. 1 is to include a battery indicator (170) on the mouse (5). The battery indicator (170) monitors and displays via conventional means the remaining power contained within the battery. This aspect solves the problem of inadvertently losing battery power in the middle of a recorded iteration of the present invention. Instead, the user can monitor the battery life. An additional embodiment includes incorporating an audio and/or visual alert into the battery indicator (170) to operate via conventional means to further alert the user of low battery life. It can be envisioned that in this embodiment, the audio and/or visual alert could be displayed either on the mouse (5) itself, or on the corresponding connected computer's screen.

As we see in FIG. 1, the preferred embodiment of the present invention also includes an operational switch (180). The operational switch (180) is used to set the mouse (5) and its corresponding communications with the computer (50) to either automatic mode (225) or manual mode (227). When the operational switch (180) is set to automatic mode (230), the aforementioned function pertaining to the recording and timing elements will commence based on the iterations determined by the setting of the position switch (40). When the operational switch (180) is set to manual mode (225), the present invention will essentially operate as a conventional mouse (5) that relies on user movement for its function. In effect, the automated functions of the mouse are deactivated.

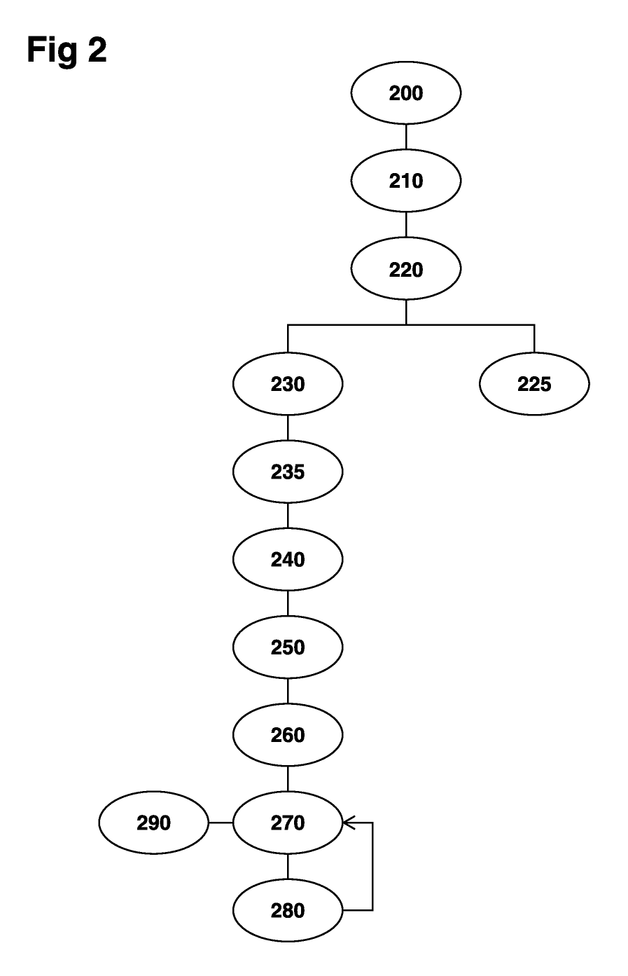

FIG. 2 is a flow chart that describes the system of the present invention in different operational terms. As we see in FIG. 2, the first step is to power on (200) the at least one associated computer and its display screen, thus creating a connection (210) from the mouse to the computer either via wireless or wired means. During the first operation, the drivers or other comparable correspondence between the mouse and the computer are incorporated into the software (220). The user will then place the operational switch onto automatic mode (230) or manual mode (225). If the operational switch is set to manual mode (225), then the mouse will only operate based on the user's physical motions. If the operational switch is set to automatic mode (230), the user may activate the recording switch (235). All functions including right clicking, left clicking, general movement, and scrolling, will then be recorded (240). When recording is finished, the user will then stop the recording (250) via the stop recording switch. Once recording is stopped, the user will select the timing of the activation of these recorded movements by choosing the top position, middle position, or bottom position of the position switch according to which preset time setting the user wishes to employ (260). After the amount of time determined by the position switch has elapsed, the recorded motions will function on the computer exactly as recorded (270), with the recording commencing again after the same amount of time as determined by the top position has elapsed (280). The recording will continue to repeat until stopped by the user (290). It can be envisioned that the recording of mouse interactions is limited only by the amount of memory available, either within the mouse (5) itself, or, as it is similarly envisioned, the recording data and metadata may be stored on the connected computer to take advantage of the computer's ample hard drive memory. It is contemplated that the recorded data and metadata logging the mouse interactions would preferably be stored on a conventional computer chip located within the mouse (5), or otherwise, located on the hard drive of the at least one connected computer.

It is envisioned that embodiments of the present invention could include supplemental functions and features that would preferably be enacted upon by the user from within the driver software on the computer, enabling communication between the present invention, and the associated at least one computer. For example, it can be envisioned that the recording feature of the present invention could be initiated not only from the physical switch located on the present invention, but from within the computer software itself.

It should be understood that the present invention is an automated computer peripheral device fashioned to perform conventional mouse actions for a user that has a recording switch configured to initiate a recording of mouse interactions and a play switch configured to play the recording of mouse interactions. The recording is stored on conventional computer memory, and is played back at the interval or frequency determined by the user.

1) An automated computer peripheral device fashioned to perform conventional mouse actions for a user, comprising:
a recording switch configured to initiate a recording of mouse interactions; and
a play switch configured to play the recording of mouse interactions.

2) The automated computer peripheral device of claim 1, wherein said recording switch is configured to record all mouse movement.

3) The automated computer peripheral device of claim 1, wherein said play switch is configured to play at a frequency.

4) The automated computer peripheral device of claim 1, wherein said play switch is configured to play at a user-defined frequency.

5) The automated computer peripheral device of claim 2, wherein said play switch is configured to play at a frequency.

6) The automated computer peripheral device of claim 2, wherein said play switch is configured to play at a user-defined frequency.

7) The automated computer peripheral device of claim 3, wherein said play switch is configured to play at a user-defined frequency.

8) The automated computer peripheral device of claim 1, further comprising an operational switch configured to be toggled between automated and conventional ‘manual’ operation.

9) The automated computer peripheral device of claim 8, wherein said recording switch is configured to record all mouse movement.

10) The automated computer peripheral device of claim 8, wherein said play switch is configured to play at a frequency.

11) The automated computer peripheral device of claim 8, wherein said play switch is configured to play at a user-defined frequency.

12) A method for performing conventional mouse actions for a user, comprising:
connecting a computer peripheral device to a computer;
actuating the computer peripheral device;
recording said actuating the computer peripheral device to produce a record; and
actuating a mouse pointer according to the record.

13) (canceled)

14) An automated computer peripheral device fashioned to perform conventional mouse actions for a user, comprising:
a recording switch configured to initiate a recording of mouse interactions;
a play switch configured to play the recording of mouse interactions;
said play switch is configured to play at a frequency; and
an operational switch configured to be toggled between automated and conventional ‘manual’ operation.
